(19) United States
(12) Patent Application Publication
(10) Pub. No.: US 2016/0144931 A1
(43) Pub. Date: May 26, 2016

(54) FOLDING HATCH COVER BLOCKING DEVICE

(71) Applicant: British Columbia Maritime Employers Association, Vancouver (CA)

(72) Inventors: Mike Duff, North Vancouver (CA); Glen Williams, North Vancouver (CA)

(21) Appl. No.: 14/549,285

(22) Filed: Nov. 20, 2014

(51) Int. Cl. B63B 19/197; B65D 71/00; B23P 19/04

(52) U.S. Cl. CPC B63B 19/197; B23P 19/04; B65D 71/00; B63B 2019/0053

(57) ABSTRACT

A stop block system for locking hydraulic cylinders is provided. The stop block system includes a plurality of axially adjacent layers that are arranged co-axially. The layers include a top layer having a bearing surface for receiving a load, one or more spacer rings for adjusting the height of the stop block system and transferring the load from the top layer to a base layer and a base layer for centering the stop block system and transferring the load from the spacer rings to a surface on which the stop block system rests. Each annular layer may be made up of two or more annular c-shaped components. The two or more components of one layer may be rotationally offset from the two or more components of axially adjacent layers.

### TECHNICAL FIELD

This invention relates to mechanical stops for hydraulic cylinders. In particular, some embodiments of the invention provide stop block systems for hydraulic cylinders used on folding hatch-covers of cargo ships.

### BACKGROUND

Hydraulic cylinders are mechanical actuators that provide a unidirectional force through a unidirectional stroke. Hydraulic cylinders get power from pressurized hydraulic fluid, such as oil. A hydraulic cylinder, as illustrated in FIG. 1, consists of a cylinder barrel, in which a piston connected to a cylinder shaft moves back and forth. The barrel is closed by the cylinder head at the end where the piston rod protrudes and by the cylinder bottom at the other end. The piston has sliding rings and seals to maintain pressure within the barrel. Hydraulic cylinders have many applications. Particular applications include, but are not limited to, construction equipment, manufacturing machinery, airplanes and marine folding hatch-covers.

It is common for hydraulic cylinders to be capable of imparting a significant amount of force. However, it may not always be practical to sustain large loads for long periods of time. Accordingly, it may be beneficial to provide a locking mechanism for applications that require sustained loading. One application that may require sustained loading is the opening and closing of folding hatch-covers.

Cargo ships, ocean-going marine bulk carriers and container feeder ships may include cargo hatches which are covered by folding hatch-covers, as illustrated in FIG. 2. Folding hatch-covers generally consist of two generally flat and rectangular panels pivotally connected to each other. When the folding hatch-cover is closed, the two panels lie flat across a hatch opening, thereby closing the opening. The outside end of one of the panels (i.e. the end not attached to the second panel) is pivotally mounted to one end of the hatch opening. The outside end of the second panel (i.e. the end not attached to the first panel) has a sliding mechanism to allow slidable movement of the second panel along the side edges of the hatch opening. Commonly, this mechanism consists of a set of wheels mounted at opposite sides near the outside end of the second panel, as illustrated in FIG. 2. To open the folding hatch-cover and provide access to the of the cargo hatch, the first panel is moved from its flat position to a vertical or near vertical position.

To move the panel, force is typically applied by way of hydraulic cylinder. Hydraulic cylinders, as used for opening and closing folding hatch-covers typically have cylinder shafts with diameters in the range of 5 to 10 inches. As the first panel moves towards a vertical position, the inside end of the second panel is raised up due to the pivotal attachment of the two panels. As the inside end of the second panel is raised, the outside end of the second panel slides along the edge of the hatch, thereby opening the hatch.

In some ports, such as the ports of Prince Rupert and Vancouver in British Columbia, Canada and the ports of Tacoma and Portland South, of the Northwestern United States, it is common for there to be a considerable amount of rain, at least between the months of November and April. Rain can cause problems for loading and offloading grain and other cargo from ocean-going marine bulk carriers since such cargo can be moisture sensitive.

The maximum allowable moisture content of grain cargo is typically between 10-20%. For some grains in particular, the maximum allowable moisture content is 14%. Although the maximum allowable moisture content of grain is known, it can be difficult to measure the moisture content of grain while loading and offloading grain. Further, it is not expected of the ship officers to know about moisture levels and moisture measurements and whether allowing loading or offloading to continue in a light rain will affect the quality of the grain.

One solution is for shippers and charterers to give specific instructions to shut down loading and offloading at the first sign of rain. However, shutting down cargo operations during extended periods, such as during rain, could significantly extend the loading operation. Extensive delays, such as multiple days, could easily occur even when the loading or unloading process is near to completion. Such delays may be expensive for the port, the owners and charterers of the delayed ship, and the owners and charterers of ships waiting for use of the port.

A second solution is to reduce the area of the hatch opening through which rain falls, thereby reducing the amount of water entering the cargo hold. While this method may be effective in reducing the amount of water entering the cargo hold, given the significant forces involved, it can be very difficult to maintain folding hatch-covers in a partly open position. If hydraulic cylinders are used to hold the folding hatch-covers open for long periods of time, leaking may occur in a hose, fitting, main line supply, pilot check valve, cylinder shaft seal or piston seal. Another solution for safely holding the hatch part-way open is therefore required.

The load on a hydraulic cylinder to support a folding hatch-cover is lowest when the cover is closed. As the cover is opened, the force required by the hydraulic cylinder to support the cover quickly reaches a maximum as the panels are no longer supported by their side edges and the outside end of the second panel cannot support the horizontal load since it is not horizontally fixed. As the folding hatch-cover is opened further, the horizontal component of the load decreases while the vertical component of the load, which may be supported by the outside edges of the hatch opening, increases. Accordingly, the force required from the hydraulic cylinder to support the folding hatch-cover decreases and reaches a minimum when the hatch is fully open. The load required to hold open a typical folding hatch-cover part-way is approximately 90 tonnes (198,000 lbs.). However, it is preferred that any mechanism for holding open a folding hatch-cover should be capable of sustaining a prolonged load of at least 100 tonnes (220,000 lbs.).

A number of solutions have been proposed to support the folding hatch-cover in a partially open position. Some cylinder locking systems are spring actuated pressure released radial wedge segments that surround the peripheral surface of a cylinder rod and rely on a wedge effect to lock the load. The locking ability of such a system is infinite throughout the stroke of the cylinder. However, their application is specific and integral to one cylinder.

Another solution provides a wedge placed between the outside edge of the second panel and the edge of the hatch, as illustrated in FIG. 2. Such a solution is not preferred because the wedge can be displaced causing the folding hatch-cover to slide shut unintentionally. Furthermore, such a solution only allows for the hatch to be open to a single set distance and may not work for multiple configurations of folding hatch-covers.

There remains a need for an effective, easy to install/remove system for supporting folding hatch-covers in a partially open position that is adaptable to a wide variety of vessels, will not damages vessel components and is approved and rated by all appropriate parties.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

One aspect of the invention provides a stop block system for locking hydraulic cylinders. The stop block system has a base for centering the stop block system, one or more spacers axially aligned with the base and a top bearing surface for receiving a load. The load is transferred from the top bearing surface to the one or more spacers and from the one or more spacers to the base. From the base, the load is transferred to the surface upon which the base rests. In the some applications, the load is transferred from the base to a hydraulic cylinder barrel.

In some embodiments, the base, the one or more spacers and the top bearing surface are generally held in axial alignment by way of spigots and recesses. For the purposes herein, a spigot is a short projection, sometimes cylindrical, designed to fit into a recess or a hole of another piece. In some embodiments, the spigots and recesses are circular in shape, while in other embodiments, the spigots and recesses may have a rectangular shape, a hexagonal shape or any other suitable shape.

In some embodiments each of the base, the one or more spacers and the top bearing surface comprise two or more components. In some embodiments, each of the base, the one or more spacers and the top bearing surface comprise two c-shaped components. In further embodiments, the two or more components of at least one spacer are rotationally offset from two or more components of another spacer and/or two more components of the base.

In some embodiments the rotational orientation of axially adjacent layers, such as the base, spacers or the top load bearing surface, is maintained by way of a locking mechanism. The locking mechanism may be a series of locating dowels and locating dowel holes located on the faces of the base, spacers and/or top bearing surface. The rotational offset between axially adjacent layers may be approximately 90 degrees.

In some embodiments, annular components of the base layer are attached together by threaded fasteners. The spacer rings may be made of a phenolic material. The number of spacer rings in the stop block system may be based at least in part on the position in which a hydraulic cylinder is to be locked.

Another aspect of the invention provides a method of installing a stop block system for locking hydraulic cylinders on cargo ships without disassembling the hydraulic cylinder. The method includes arranging a base around a hydraulic cylinder shaft, centering the base around the hydraulic cylinder shaft, arranging one or more spacers, in axial alignment with the base and around the hydraulic cylinder shaft and arranging a top bearing surface on top of the one or more spacers.

In some embodiments, arranging the base around they hydraulic cylinder shaft includes arranging a plurality of base components around the hydraulic cylinder shaft. Arranging each of the one or more spacers around the hydraulic cylinder shaft may include arranging a plurality of spacer components around the hydraulic cylinder shaft. In some embodiments, the one or more spacers are aligned such that the plurality of spacer components of each of the one or more spacers are rotationally offset from each of the plurality of spacer components in axially adjacent spacers. The method may also include mating locating dowels and locating dowel holes to achieve the rotational orientation of the one or more spacers. Centering the base around the hydraulic cylinder shaft may require adjusting a plurality of screws.

Another aspect of the invention provides a kit which includes one or more stop block systems for locking hydraulic cylinders on cargo ships. The stop block systems may include any of the features described herein.

In addition to the exemplary aspects and embodiments described above, further aspects and embodiments will become apparent by reference to the drawings and by study of the following detailed descriptions.

### BRIEF DESCRIPTION OF DRAWINGS

Exemplary embodiments are illustrated in referenced Figures of the drawings. It is intended that the embodiments and Figures disclosed herein are to be considered illustrative rather than restrictive.

FIG. 1 is a schematic depiction of art hydraulic cylinder, as known in the prior art.

FIG. 2 is a depiction of a folding hatch-cover in a partially-open position, as known in the prior art.

FIG. 3 depicts one embodiment of an assembled hydraulic cylinder stop block system not installed on a hydraulic cylinder.

FIG. 4 schematically depicts an assembled hydraulic cylinder stop block system installed on a hydraulic cylinder.

FIG. 5A depicts one embodiment of a base ring.

FIG. 5B depicts a first component of the base ring illustrated in FIG. 5A.

FIG. 5C is a top perspective view of a second component of the base ring illustrated in FIG. 5A and FIG. 5D is a bottom perspective of a second component of the base ring illustrated in FIG. 5A.

FIG. 6A depicts one embodiment of a spacer ring, comprising two spacer components.

FIGS. 6B and 6C are bottom and top perspective views of a first spacer component of the spacer ring illustrated in FIG. 6A.

FIG. 7A depicts one embodiment of a top load bearing ring component.

FIGS. 7B and 7C respectively depict an upper spacer component and a contact plate component of a top load bearing ring, as illustrated in FIG. 7A.

FIGS. 8A and 8B depict the hydraulic cylinder to hatch-cover connection of the Azalea K (bulk carrier) ship.

FIGS. 9A and 9B depict the hydraulic cylinder to hatch-cover connection of the JS Comet (bulk carrier) ship.

FIGS. 10A and 10b depict the hydraulic cylinder to hatch-cover connection of the Queen Kobe (bulk carrier) ship.

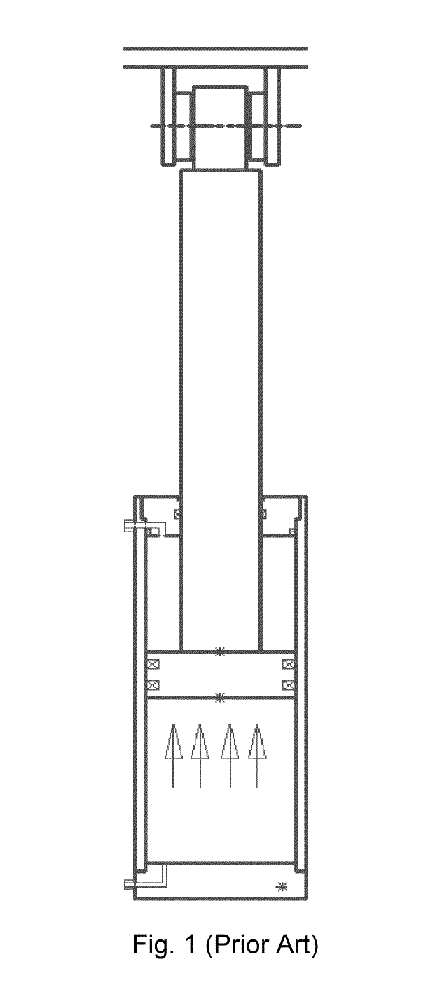

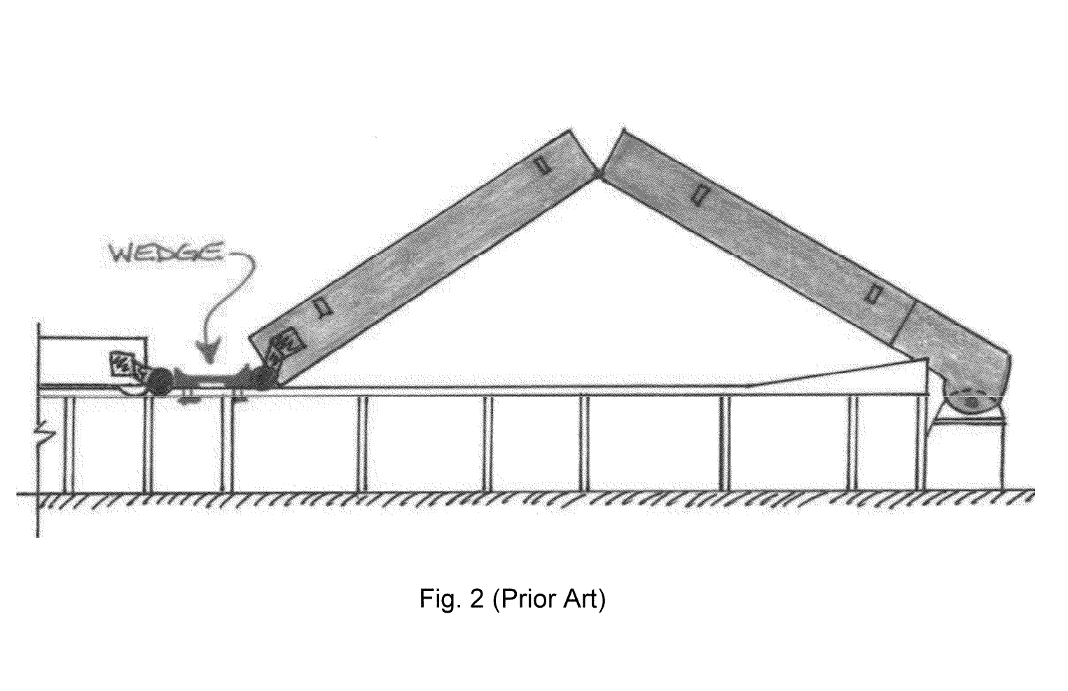

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

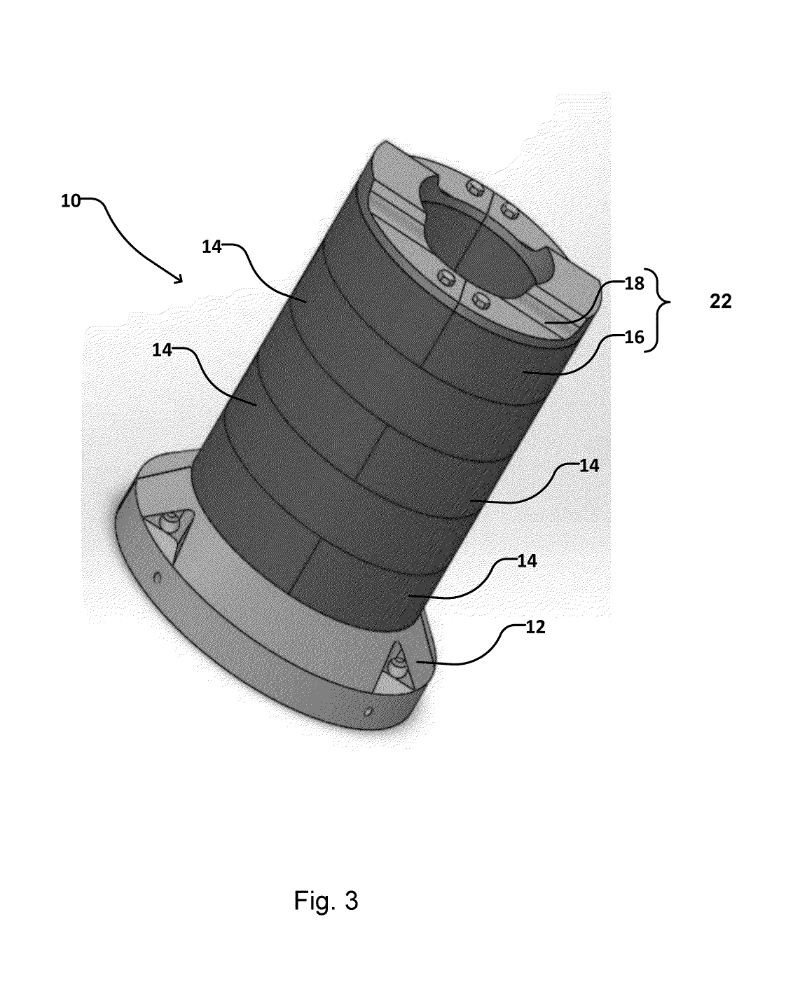

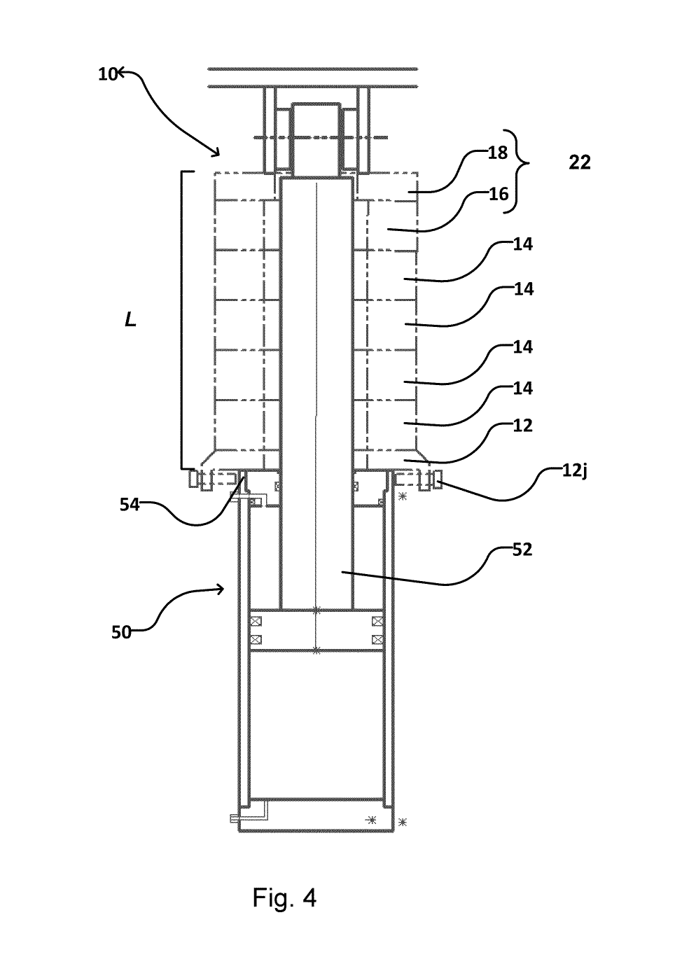

One aspect of the invention provides a stop block system for a hydraulic cylinder. In some embodiments, the hydraulic cylinder may be part of a folding hatch-cover. One embodiment of a stop block system 10 is illustrated in FIG. 3. As illustrated in FIG. 4, stop block system 10 can be mounted to a hydraulic cylinder such as hydraulic cylinder 50. Mounting stop block system 10 to hydraulic cylinder 50 as illustrated in FIG. 4 prevents hydraulic cylinder 50 from compressing by length L of stop block system 10.

Stop block system 10 is modular. In particular, stop block system 10 includes base ring 12, one or more spacer rings 14 and top load bearing ring 22. The details of each part and their interrelationships are described in more detail below.

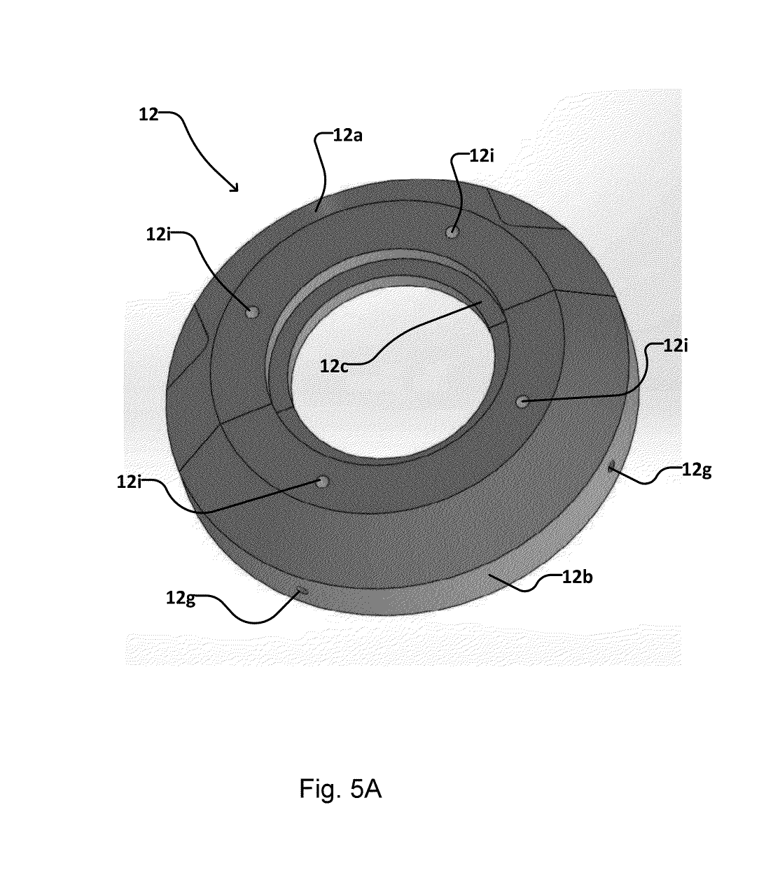

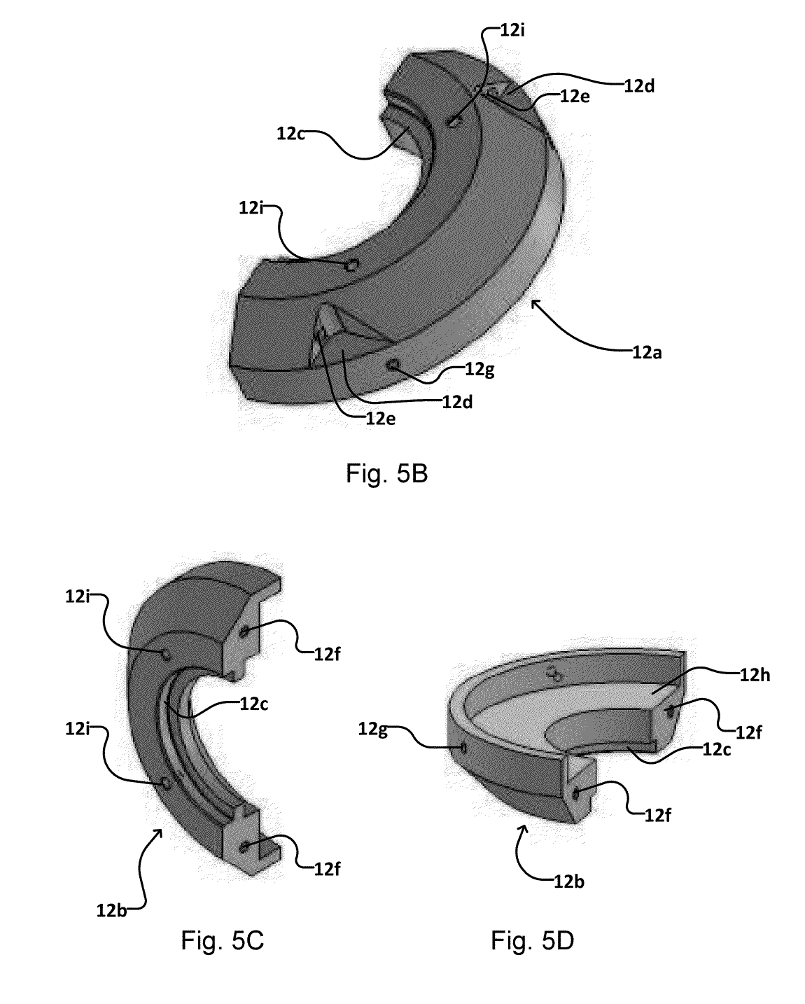

FIGS. 5A through 5D depict one embodiment of base ring 12. Base ring 12 may have a plurality of annular components mated together. As illustrated in FIG. 5A, base ring 12 may comprise two semi-circular components 12a and 12b. Each semi-circular component 12a and 12b may have flat vertical faces that can be mated together to form complete circular base ring 12. Semi-circular components 12a and 12b may be locked together by way of threaded fasteners. As illustrated in FIG. 5B, base ring component 12a includes recesses 12d and apertures 12e for receiving fasteners. Likewise, base ring component 12b includes threaded apertures 12f for receiving fasteners. In other embodiments, base component 12 may comprise any number of components. In some embodiments, base ring 12 may include two or more components attached to each other by way of a hinge or other pivoting mechanism. The multi-part nature of base ring 12 allows base ring 12 to be arranged around cylinder shaft 52 or cylinder head 54 of hydraulic cylinder 50 without dismantling hydraulic cylinder 50.

Base ring 12 may also include a centering mechanism for centering base ring 12 around cylinder shaft 52. For example, in some embodiments, one or more adjustable thumb screws point radially inward from each of semi-circular components 12a and 12b for centering base ring 12. As can be seen in FIGS. 5B through 5D, base ring 12 may include apertures 12g for receiving adjustable thumb screws 12j or the like. By adjusting each thumb screw 12j by the same amount until cylinder shaft 52 of hydraulic cylinder 50 is securely contacted, base ring 12 can be securely positioned co-axially with hydraulic cylinder 50. In other embodiments, one or more of springs or shims may be provided for centering base ring 12. In further embodiments still, alternative centering means may be provided. Co-axial positioning creates co-axial loading of stop block system 10 and may prevent unstable loading. There is a danger of instability of the load if the load is not transferred co-axially into stop block system 10. This could create a tendency for a spacer ring or a combination of spacer rings to slip, since the spacer rings are arranged around the periphery of the shaft.

A first face of base ring 12 may include recessed base portion 12h for receiving cylinder head 54 of hydraulic cylinder 50, as illustrated in FIG. 4. Recessed base portion 12h may be made in different shapes to fit different hydraulic cylinders. Recessed base portion 12h may include one or more stepped levels of varying diameters and may be surrounded with a lip to ensure base ring 12 securely engages hydraulic cylinder 50.

A second face of base ring 12 may include recessed portion 12c for securely receiving spacer ring 14. For example, as illustrated in FIG. 5C, the interior edge of the second face of base ring 12 includes circular recessed portion 12c for receiving spacer ring 14. Recessed portion 12c ensures that spacer ring 14 mates securely with base ring 12 and that spacer ring 14 is maintained in a co-axial relationship to cylinder shaft 52. Alternatively, the second face of base ring 12 may comprise a spigot to be received by spacer ring 14.

Base ring 12 may also include one more locating dowel holes 12i recessed in the second face to receive spacer ring 14. Locating dowels holes 12i may be provided to secure the rotational orientation of axially adjacent layers (e.g. base ring 12 and spacer ring 14). As will be described in further detail below, it may be beneficial to orient spacer rings 14 in particular ways. In some embodiments, base ring 12 may include four equally spaced locating dowel holes 12i on the second side. In other embodiments, the number and spacing of locating dowel holes 12i may vary. The locations of locating dowel holes 12i may be dependent on the preferred rotational orientation of adjacent layers, such as spacer ring 14, as will be described in more detail below.

Alternatively, base ring 12 may include one more locating dowels protruding from the second face to be received by spacer ring 14. In further embodiments, base ring 12 may include a combination of locating dowels and locating dowel holes on the second face for mating with spacer ring 14.

Locating dowels may be cylindrical in shape or may be of any other suitable shape such as a rectangular prism, or a hexagonal prism. Locating dowel holes are preferably shaped to securely receive locating dowels. Dowels may be made of a strong material such as aluminum, steel, composite or another suitable material. It is preferred that the dowels are not susceptible to corrosion. In particular embodiments, dowels are made of type 316 stainless steel.

Base ring 12 may be made of any suitable strong and lightweight material capable of withstanding the required compressive loads. It is preferred that the material will not cause damage to cylinder shafts during installation. In some embodiments, base ring 12 is made of aluminum, such as 6061-T6 aluminum. In other embodiments, base ring 12 may be made of other materials such as steel or a suitable composite material. To ease installation, base ring 12 may weigh less than 40 pounds.

While base ring 12 is often described herein as being annular, circular or round, it should be understood that the outside perimeter and central aperture of base ring 12 may be of any suitable shape. For example, each of the outside perimeter and central aperture of base ring 12 may take the shape of any of at least a square, a triangle, a hexagon, an oval, or a generally polygonal shape.

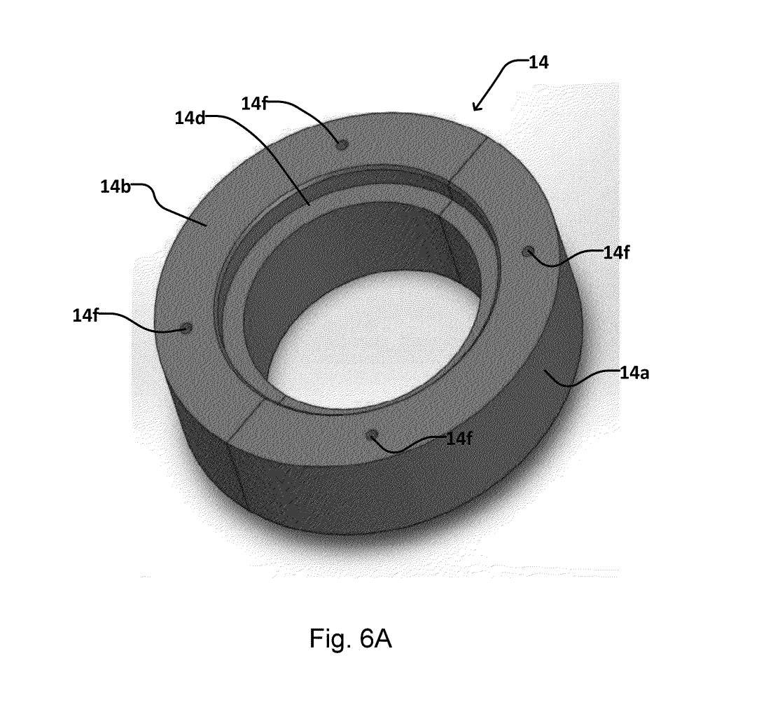

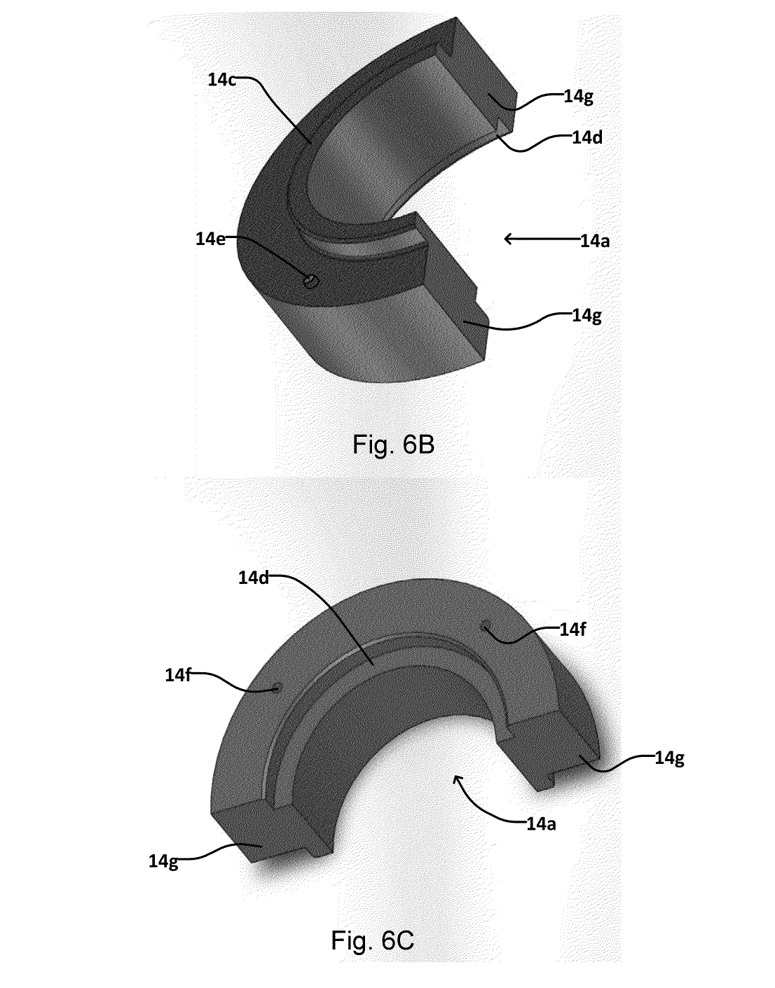

FIGS. 6A through 6C depict one embodiment of spacer ring 14. Each individual spacer ring 14 may consist of two or more annular spacer components. For example, FIG. 6A depicts an embodiment of spacer ring 14 having c-shaped spacer components 14a and 14b. Each spacer component may have radial edges 14g that contact radial edges 14g of circumferentially adjacent segments. In this embodiment, spacer components 14a and 14b are identical. In other embodiments, spacer components 14a and 14b may be different. For example, they may be configured to have male and female connections on radial edges 14g or individual components can make up varying proportions of the circumference of spacer ring 14. For simplicity and ease of installation, it is preferred that spacer rings 14 comprise 2 c-shaped spacer components 14a and 14b.

As illustrated in FIG. 6B, a first face of spacer ring 14 may include integral co-axial spigot 14c. Spigot 14c may be shaped to fit securely into recessed portion 12c of base ring 12. By fitting spigot 14c into recessed portion 12c of base ring 12, spacer ring 14 is secured in a position co-axial to base spacer 12. Spigot 14c may also be shaped to fit securely into a recessed portion of additional spacer rings 14 as will be described below. As described above, this co-axial relationship provides improved loading characteristics.

The first face of spacer ring 14 may also include one or more of locating dowel holes and/or locating dowels to mate with the corresponding locating dowels and/or locating dowel holes of base spacer 12. FIG. 6B depicts the first face of spacer ring 14 having locating dowels 14e. The locating dowels and/or locating dowel holes secure the orientation of the plurality of spacer components with respect to base ring 12. As will be described in further detail below, it may be beneficial to orient spacer rings 14 in particular ways. In some embodiments, spacer ring 14 may include four equally spaced locating dowels 14e on the first side. In other embodiments, the number and spacing of locating dowels 14e may vary. The locations of locating dowels 14e may be dependent on the preferred relative orientation of adjacent layers, such as additional spacer rings 14, as will be described in more detail below.

Locating dowels may be cylindrical in shape or may be of any other suitable shape such as a rectangular prism, or a hexagonal prism. Locating dowel holes are preferably shaped to securely receive locating dowels. Dowels may be made of a strong material such as aluminum, steel, composite or another suitable material. It is preferred that the dowels are not susceptible to corrosion. In particular embodiments, dowels are made of type 316 stainless steel.

As illustrated in FIG. 6C, the second face of spacer ring 14 may include integral co-axial recess 14d for receiving spigot 14c of an additional spacer ring 14. By fitting spigot 14c of a first spacer ring 14 into recess 14d of a second spacer ring 14, both spacer rings are securely held in a co-axial relationship. As described above, this co-axial relationship provides improved loading characteristics. In other embodiments, spigot 14c and recess 14d may be reversed.

The second face of spacer ring 14 may also include one or more of locating dowel holes or locating dowels to mate with the corresponding locating dowels and/or locating dowel holes of base spacer 12. FIG. 6C depicts the first face of spacer ring 14 having locating dowel holes 14f. The locating dowels and/or locating dowel holes secure the orientation of the plurality of spacer components with respect to base ring 12 or other spacer rings 14. As will be described in further detail below, it may be beneficial to orient spacer rings 14 in particular ways. In some embodiments, spacer ring 14 may include four equally spaced locating dowel holes 14f on the second side. In other embodiments, the number and spacing of locating dowel holes 14f may vary. The locations of locating dowel holes 14f may be dependent on the preferred relative orientation of adjacent layers, such as additional spacer rings 14, as will be described in more detail below.

Locating dowels may be cylindrical in shape or may be of any other suitable shape such as a rectangular prism, or a hexagonal prism. Locating dowel holes are preferably shaped to securely receive locating dowels. Dowels may be made of a strong material such as aluminum, steel, composite or another suitable material. It is preferred that the dowels are not susceptible to corrosion. In particular embodiments, dowels are made of type 316 stainless steel.

In some embodiments, spacer rings 14 are made of a material with high compressive strength, and low weight. To ease installation, spacer ring 14 may weigh less than 20 pounds. The spacer rings should be able to withstand repeated loads of 100 tonnes (220,000 lbs) without breaking and with minimal deflection. Suitable materials may include steel, aluminum and composite materials. Preferably, a composite material such as a phenolic material is employed. Phenolic materials have a low density, a high compressive strength and will not damage the chromed sealing surface of a hydraulic cylinder shaft in the event of direct contact during installation.

While spacer rings 14 are often described herein as being annular, circular or round, it should be understood that the outside perimeters and central apertures of spacer rings 14 may be of any suitable shape. For example, each of the outside perimeter and central aperture of a spacer ring 14 may take the shape of any of at least a square, a triangle, a hexagon, an oval, or a generally polygonal shape.

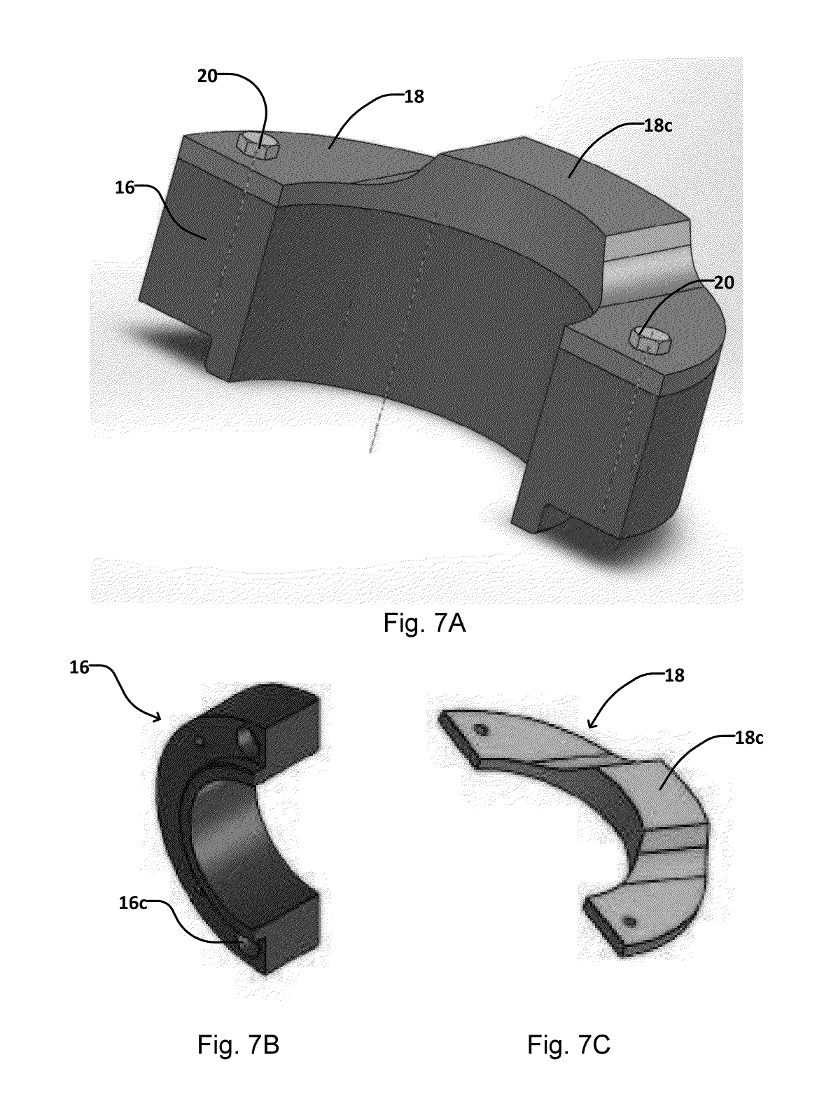

As depicted in FIG. 7A, top load bearing ring 22 may comprise upper spacer 16 and contact plate 18. Top load bearing ring 22 may comprise two or more components. Top load bearing ring components are typically assembled before installation on to hydraulic cylinder 50. However, in some embodiments, it may be assembled after being mounted on hydraulic cylinder 50.

Upper spacer 16 may be substantially similar to spacer ring 14 in size, configuration and material. Upper spacer 16 may consist of two or more upper spacer components 16a and 16b. Similar to spacer ring 14, upper spacer components 16a and 16b can be identical or can be different. Similar to spacer ring 14, upper spacer components 16a and 16b can be c-shaped or can be of various proportions of the circumference of a ring, as long as the upper collar components add up to one full circumference. Unlike spacer ring 14, upper spacer 16 may be configured to receive contact plate 18. In some embodiments, all spacer rings 14 may be identical to upper spacer 16. Upper spacer 16 may include an aperture for receiving a retaining bolt 20 and nut for securing upper spacer 16 to contact plate 18. FIG. 7B illustrates one such embodiment having recesses and apertures 16c for receiving retaining bolt 20 and nut. In other embodiments, alternative securing means may be employed.

As illustrated in FIG. 7A, upper spacer 16 is installed axially adjacent contact plate 18. In some configurations, upper spacer 16 may be the only spacer between base ring 12 and contact plate 18. In other embodiments, one or more spacer rings 14 may be located between base ring 12 and upper spacer 16.

While upper spacer 16 is often described herein as being annular, circular or round, it should be understood that the outside perimeter and central aperture of uppers spacer 16 may be of any suitable shape. For example, each of the outside perimeter and central aperture of upper spacer 16 may take the shape of any of at least a square, a triangle, a hexagon, an oval, or a generally polygonal shape.

FIG. 7C depicts one half of contact plate 18. Contact plate 18 is a ring shaped layer having two or more annular components. Contact plate 18 is configured to be secured to upper spacer 16. In some embodiments, contact plate 18 is secured to upper spacer 16 by way of bolts 20. Bolts 20 may be received by upper spacer 16 and fastened with nuts. In other embodiments, contact plate 18 may include threaded apertures for receiving bolts 20.

Contact plate 18 may be configured to fit one or more types of cylinder to hatch-cover connection. The weight of the hatch is transferred from the cylinder to hatch-cover connection to stop block system 10 by way of contact plate 18. Accordingly, contact plate 18 should provide a secure and stable connection between the upper spacer 16 and the cylinder to hatch-cover connection such that the full load of the hydraulic cylinder is received by stop block system 10. In the embodiment illustrated in FIG. 7C, contact plate 18 has a raised section 18c for contacting a cylinder to hatch-cover connection. The load of the folding hatch-cover is transferred to stop block system 10 by way of raised section 18c.

Raised section 18c may be smooth like a bearing surface to allow the hatch-cover connection to rotate while in contact with raised section 18c. This is beneficial since the angle of the hatch relative to the angle of hydraulic cylinder 50 changes as the hatch is lowered onto stop block system 10.

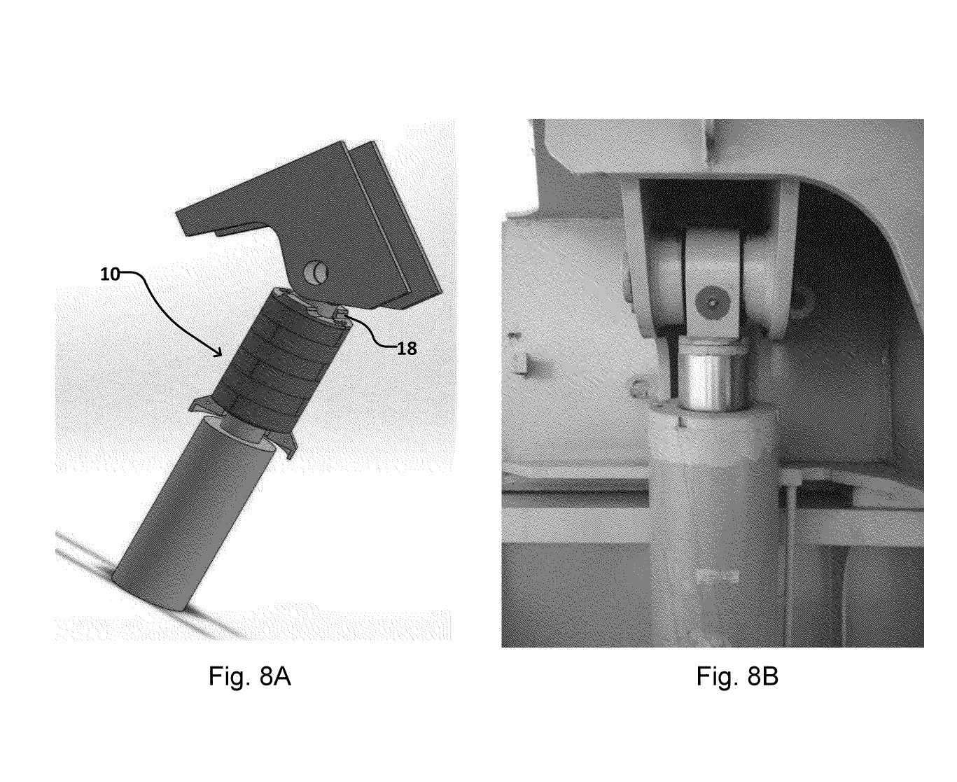

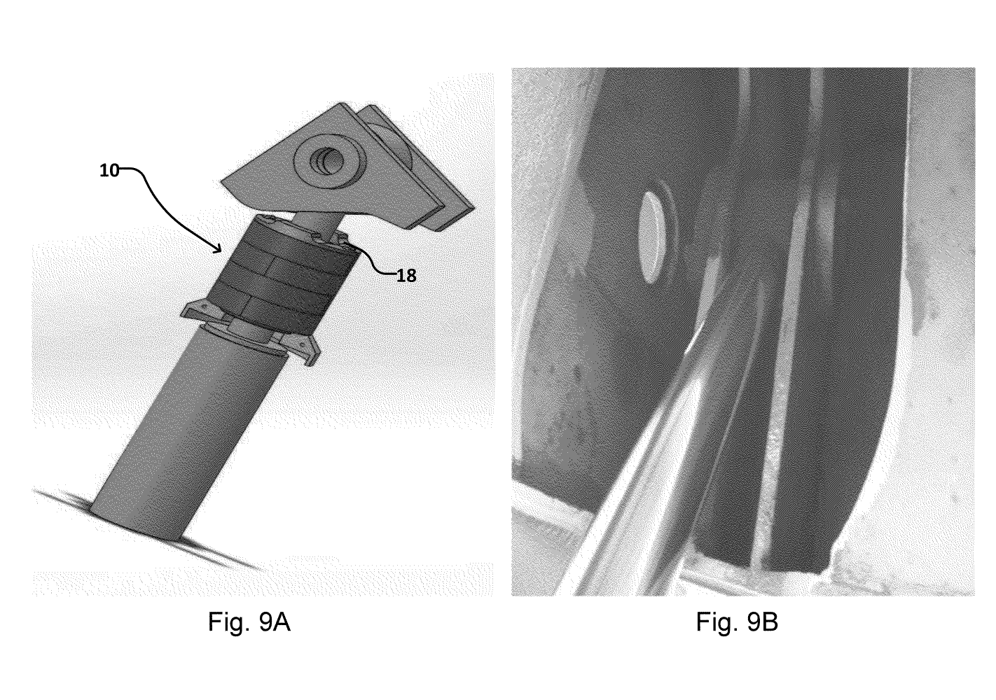

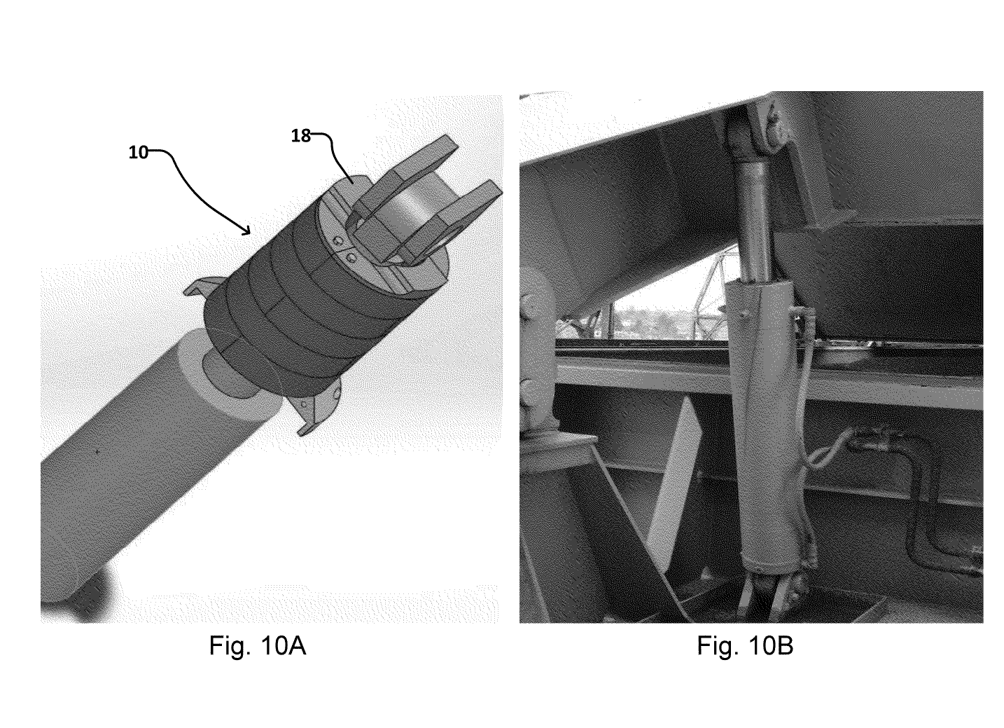

As discussed above, not all cylinder to hatch-cover connections have the same shapes and geometries. Accordingly, it may be required that different contact plates 18 are designed for different hydraulic cylinders, hatches and cylinder to hatch-cover connections. For example, FIGS. 8A and 8B illustrate the hydraulic cylinder to hatch-cover connection of the Azalea K ship, FIGS. 9A and 9B illustrate the hydraulic cylinder to hatch-cover connection of the JS Comet ship and FIGS. 10A and 10B illustrate the hydraulic cylinder to hatch-cover connection of the Queen Kobe ship. The embodiment of contact plate 18 as illustrated in FIGS. 7A-10B is configured to suitably transfer the load of the hatch-covers to stop block system 10 for each of the Azalea K, JS Comet and Queen Kobe ships. Other ships may require an altered design.

In some embodiments, contact plate 18 may be made of steel. In particular, contact plate 18 may be made of hardened steel such as QT400 grade steel with medium hardness. In other embodiments, contact plate 18 may be made of another material such as aluminum or a composite material. Contact plate 18 may have an extra hard coating such as a ceramic coating to minimize wear.

While contact plate 18 is often described herein as being annular, circular or round, it should be understood that the outside perimeter and central aperture of contact plate 18 may be of any suitable shape. For example, each of the outside perimeter and central aperture of contact plate 18 may take the shape of any of at least a square, a triangle, a hexagon, an oval, or a generally polygonal shape.

As can be seen in FIG. 3, the orientation of base ring components 12a and 12b, spacer components 14a and 14b and upper spacer components 16a and 16b may vary along the length of stop block system 10. For example, a first spacer ring 14 may have components rotated 90 degrees relative to axially adjacent base ring components 12a and 12b. In the FIG. 3 embodiment, the components of each axially adjacent spacer ring 14 have a rotational offset of 90 degrees. Upper spacer 18 may also be rotated 90 degrees in relation to axially adjacent components. In some embodiments, contact plate 18 has a substantially equal orientation to upper spacer 16, such as is illustrated in FIG. 7A. In other embodiments, contact plate 18 is rotated by 90 degrees in relation to upper spacer 16.

Maintaining different orientations between axially adjacent spacer rings and rings ensures that the components of each spacer will not separate under loading or during installation. Maintaining different orientations between axially adjacent spacer rings also avoids the need for spacer components 14a and 14b of spacer ring 14 to be attached to one another by other means. Such a configuration ensures that stop block system 10 does not break apart into its components when loaded.

In other embodiments, axially adjacent components are rotated by an angle other than 90 degrees (or 270 degrees). Preferably, where each layer comprises two components, the angle of rotation is not an integer multiple of 180 degrees. In embodiments where any of base ring 12, spacer rings 14, upper spacer 16 and contact plate 18 consist of more than two components, the angle of rotation should be chosen such that any of the contact surfaces (i.e. radial edges 14g) between components of a single layer are not oriented equally to any of the contact surfaces of components of an axially adjacent layer.

To achieve the desired relative rotational offset between axially adjacent layers of stop block system 10, locating dowels and locating dowel holes on base ring 12, spacer rings 14, upper spacer 16 and/or contact plate 18 are arranged so as to set the angle of rotation of axially adjacent layers. In particular, depending on the number of components in each layer, the locations of the locating dowels and locating dowel holes may vary. In some embodiments, locating dowel holes and locating dowels are arranged so as to allow only a single rotational orientation between axially adjacent layers. In other embodiments, locating dowel holes and locating dowels are arranged so as to allow for multiple rotational orientations between axially adjacent layers.

Stop block system 10 may be sold as part of a kit. The kit may include one or more of each of base ring 12, spacer ring 14 and top load bearing ring 22. For folding hatch-covers moved using two hydraulic cylinders, a kit may include 2 of each of base ring 12 and top load bearing ring 22 and a plurality of spacer rings 14. The kit may include at least as many spacer rings 14 as would be required to hold a folding hatch-cover in a partially open position and may include extra spacer rings 14 to replace lost or damaged spacer rings 14.

In practice, stop block system 10 is preferably installed in a series of steps. During installation, the folding hatch door must be opened wider than it will be held open by stop block system 10 so as to allow stop block system 10 to be installed. With hydraulic cylinder 50 in at least a partially open configuration, a first component of the base ring 12a is placed around cylinder shaft 52. A second base ring component 12b is then placed around cylinder shaft 52 and attached to the first base ring component 12a. If necessary, additional base ring components are placed around the hydraulic cylinder until base ring 12 surrounds the circumference of cylinder shaft 52. Preferably though, only two base ring components are used. All of the base ring components are then secured together (using threaded fasteners, for example) to form complete base ring 12. Once base ring 12 is complete, it is centered and secured to hydraulic cylinder 50. In one embodiment, this requires tightening a plurality of adjustable thumb screws 12j until each thumb screw 12j is in resilient contact with cylinder shaft 52 or cylinder head 54, as illustrated in FIG. 4. Each thumb screw 12j should be tightened equally such that cylinder shaft 52 is centered within base ring 12.

Once base ring 12 is securely in place, a first spacer component 14a is placed around the cylinder shaft and is rotated around the cylinder shaft such that any locating dowels and locating dowel holes of base ring 12 and spacer ring 14 are aligned to achieve the rotational orientation as described above. Next, the first spacer component 14a is slid down until it contacts base ring 12 and the locating dowels and locating dowel holes are securely engaged. Next, a second spacer component 14b is placed around the cylinder shaft and slid down until it contacts base ring 12. If necessary, additional spacer components are placed around the hydraulic cylinder until spacer ring 14 is complete. In some embodiments where there are no dowels and spigots on base 12 and spacer rings 14, the sliding step may not be necessary.

Depending on how far the hatch is to be held open, additional spacer rings 14 may be installed by repeating the steps above, as needed. Each additional spacer ring 14 that is installed should be rotated in relation to the previously installed (axially adjacent) spacer ring 14. The amount of rotation depends on how many components each spacer ring 14 has. In typical embodiments, where each spacer ring 14 has two components 14a and 14b, the rotational offset may be approximately 90 degrees. The number of spacer rings 14 required increases as the desired hatch opening distance increases.

Once a sufficient number of spacer rings 14 is installed, upper spacer 16 and contact plate 18 may be installed together. In some embodiments, this may require attaching contact plate 18 to upper spacer 16 to make top load bearing ring 22 and then top load bearing ring 22 is installed on hydraulic cylinder 50. In some embodiments, one or more bolts 20 and nuts attach upper spacer 16 to contact plate 18. Once assembled, upper spacer 16 and contact plate 18 are installed by following similar steps as described above in relation to spacer rings 14.

Finally, after stop block system 10 is installed as detailed above, the folding hatch-cover may be slowly lowered until the weight of the hatch-cover rests on stop block system 10. In this way, the load of the folding hatch-cover is supported by stop block system 10 and not the pressurized fluid of hydraulic cylinder 50.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A stop block system for locking hydraulic cylinders on cargo ships, the stop block system comprising:
a base for centering the stop block system;
one or more spacers axially aligned with the base; and
a top bearing surface connected to one of the one or more spacers.

2. The stop block system of claim 1 wherein the base, the one or more spacers and the top bearing surface are generally held in axial alignment by way of spigots and recesses.

3. The stop block system of claim 2 wherein each of the base, the one or more spacers and the top bearing surface comprise two or more components.

4. The stop block system of claim 3 wherein at least one spacer comprises two or more components and the two or more components of the at least one spacer are rotationally offset from the two or more components of an axially adjacent spacer or the two or more components of the base.

5. The stop block system of claim 4 wherein the rotational offset is approximately 90 degrees.

6. The stop block system of claim 3 wherein a rotational orientation of at least one of the base, the one or more spacers and the top bearing surface is maintained by way of a locking mechanism.

7. The stop block system of claim 6 wherein the locking mechanism is a combination of locating dowels and locating dowel holes on contacting faces of any or all of the base, the one or more spacers and the top bearing surface.

8. The stop block system of claim 1 wherein the base, the one more spacers and the top bearing surface are annular.

9. The stop block system of claim 3 wherein each of the base, the one or more spacers and the top bearing surface comprise two c-shaped components

10. The stop block system of claim 1 wherein the base comprises a plurality of substantially radially-oriented adjustable screws for centering the base.

11. The stop block system of claim 1 wherein a number of spacers in the stop block system is based at least on a position in which a hydraulic cylinder is to be locked.

12. The stop block system of claim 3 wherein the one or more components of the base are attached together by threaded fasteners.

13. The stop block system of claim 1 wherein the one or more spacers comprise a phenolic material.

14. A method of installing a stop block system for locking hydraulic cylinders on cargo ships without disassembling the hydraulic cylinder, the method comprising:
arranging a base around a hydraulic cylinder shaft;
centering the base around the hydraulic cylinder shaft;
arranging one or more spacers around the hydraulic cylinder shaft atop the base, each of the one or more spacers arranged co-axially with the base; and
arranging a top bearing surface on top of a top-most spacer of the one or more spacers.

15. The method of claim 14 wherein arranging the base around the hydraulic cylinder shaft comprises arranging a plurality of base components together around the hydraulic cylinder shaft.

16. The method of claim 14 wherein arranging each of the one or more spacers around the hydraulic cylinder shaft comprises arranging a plurality spacer components together around the hydraulic cylinder shaft.

17. The method of claim 14 comprising aligning each of the one or more spacers such that each of the plurality of spacers is rotationally offset from each axially adjacent spacer.

18. The method of claim 17 wherein aligning each of the one or more spacers comprises mating locating dowels and locating dowel holes.

19. The method of claim 12 wherein centering the base around the hydraulic cylinder shaft comprises adjusting a plurality of substantially radially-oriented screws.

20. A kit comprising;
one or more stop block systems for locking hydraulic cylinders on cargo ships; and
a container for receiving and transporting the one or more stop block systems for locking hydraulic cylinders on cargo ships;
wherein each stop block system comprises:
a base for centering the stop block system;
a plurality of spacers axially alignable with the base; and
a top bearing surface connectable to one of the one or more spacers.

21. A kit comprising a plurality of stop block systems for locking hydraulic cylinders on cargo ships, wherein each of the plurality of stop block systems comprises a stop block system according to any one of claims 1 to 13.
